(19) United States
(12) Patent Application Publication
(10) Pub. No.: US 2016/0329587 A1
(43) Pub. Date: Nov. 10, 2016

(54) FUEL CELL SYSTEM

(71) Applicant: LG Fuel Cell Systems, Inc., North Canton, OH (US)

(72) Inventors: Theodore R. Ohrn, Alliance, OH (US); Benjamin A. Haberman, Toronto (CA); Carlos Martinez Baca, Akron, OH (US); Michele Bozzolo, Derby (GB); Gerard D. Agnew, Uttoxeter (GB); David Beedie, Derby (GB)

(21) Appl. No.: 14/706,726

(22) Filed: May 7, 2015

(51) Int. Cl. H01M 8/12

(52) U.S. Cl. CPC H01M 8/1286; H01M 8/1246; H01M 2300/0071; H01M 2008/1293

(57) ABSTRACT

In some examples, solid oxide fuel cell system including a tubular substrate defining a fuel flow cavity within the tubular substrate; a plurality of solid oxide fuel cells on a surface of the tubular substrate, each cell including an anode electrode, a cathode electrode, and electrolyte, wherein the anode electrode, cathode electrode, and electrolyte are configured to form an electrochemical cell, wherein, during fuel cell during operation, fuel flows within the fuel flow cavity of the tubular substrate along a fuel flow direction from an inlet to an outlet of the fuel flow cavity, and wherein a permeability of the tubular substrate to the fuel varies along the fuel flow direction.

### TECHNICAL FIELD

The disclosure generally relates to fuel cells, such as solid oxide fuel cells.

### BACKGROUND

Fuel cells, fuel cell systems and interconnects for fuel cells and fuel cell systems remain an area of interest. Some existing systems have various shortcomings, drawbacks, and disadvantages relative to certain applications. Accordingly, there remains a need for further contributions in this area of technology.

### SUMMARY

Example solid oxide fuels cell systems, as well as techniques for making and using the same, are described. For example, example solid oxide fuel cell systems of the disclosure may be configured for on-cell reforming of a hydrocarbon fuel in the fuel source. The system may include a tubular substrate defining a fuel cavity and separating the fuel from a solid oxide fuel cell on a surface of the substrate. The cell itself may include of an anode electrode, a solid electrolyte, and a cathode electrode on the top surface. The permeability of the substrate to the fuel may be varied along the direction of fuel flow within the cavity to control the rate of transport of the hydrocarbon fuel across the substrate to active anode(s) of the solid oxide fuel cells. The active anode electrode may also act as a reforming catalyst for on-cell reforming in the system. In some examples, the permeability of the substrate along the fuel flow direction may be selected to provide for substantially uniform consumption of the hydrocarbon fuel in the fuel source to minimize temperature gradients in the system along the fuel flow direction.

In one example, the disclosure is directed to a solid oxide fuel cell system a tubular substrate defining a fuel flow cavity within the tubular substrate; a plurality of solid oxide fuel cells on a surface of the tubular substrate, each cell including an anode electrode, a cathode electrode, and electrolyte, wherein the anode electrode, cathode electrode, and electrolyte are configured to form an electrochemical cell, wherein, during fuel cell during operation, fuel flows within the fuel flow cavity of the tubular substrate along a fuel flow direction from an inlet to an outlet of the fuel flow cavity, and wherein a permeability of the tubular substrate to the fuel varies along the fuel flow direction.

In another example, the disclosure is directed to a method comprising generating electricity via a solid oxide fuel cell system, wherein the solid oxide fuel cell system comprises a tubular substrate defining a fuel flow cavity within the tubular substrate; a plurality of solid oxide fuel cells on a surface of the tubular substrate, each cell including an anode electrode, a cathode electrode, and electrolyte, wherein the anode electrode, cathode electrode, and electrolyte are configured to form an electrochemical cell, wherein, during fuel cell during operation, fuel flows within the fuel flow cavity of the tubular substrate along a fuel flow direction from an inlet to an outlet of the fuel flow cavity, and wherein a permeability of the tubular substrate to the fuel varies along the fuel flow direction.

In another example, the disclosure is directed to a method comprising forming a solid oxide fuel cell system, wherein the solid oxide fuel cell system comprises a tubular substrate defining a fuel flow cavity within the tubular substrate; a plurality of solid oxide fuel cells on a surface of the tubular substrate, each cell including an anode electrode, a cathode electrode, and electrolyte, wherein the anode electrode, cathode electrode, and electrolyte are configured to form an electrochemical cell, wherein, during fuel cell during operation, fuel flows within the fuel flow cavity of the tubular substrate along a fuel flow direction from an inlet to an outlet of the fuel flow cavity, and wherein a permeability of the tubular substrate to the fuel varies along the fuel flow direction.

The details of one or more embodiments of the disclosure are set forth in the accompanying drawings and the description below. Other features, objects, and advantages of the disclosure will be apparent from the description and drawings, and from the claims.

### BRIEF DESCRIPTION OF DRAWINGS

The description herein makes reference to the accompanying drawings wherein like reference numerals refer to like parts throughout the several views.

FIGS. 1A-1C are schematic diagrams illustrating an example fuel cell stack from top, side, and bottom views, respectively.

FIG. 2 is a schematic diagram illustrating a cross-sectional view taken along cross-section A-A shown in FIG. 1A.

FIG. 3 is a schematic diagram illustrating a cross-sectional view taken along cross-section B-B shown in FIG. 2.

FIGS. 4A-4C are schematic diagrams illustrating an example fuel cell system including two bundles from top, end, and side views, respectively.

FIG. 5 is a plot illustrating a profile of bulk methane for an experiment carried out to evaluate aspects of examples of the disclosure.

FIG. 6 is a plot illustrating a profile of methane flux for an experiment carried out to evaluate aspects of examples of the disclosure.

FIGS. 7A-7D illustrate temperature profiles corresponding to the experiments of FIGS. 5 and 6.

### DETAILED DESCRIPTION

As described above, example solid oxide fuel cell systems of the disclosure may be configured for on-cell reforming of a hydrocarbon fuel in the fuel source. The system may include a tubular substrate defining a fuel cavity and separating the fuel from a solid oxide fuel cell on a surface of the substrate. Tube substrates are connected in series into bundles which constitute the fuel flow circuit for each fuel pass. Bundles are then stacked up in parallel to form strips, and then strips are stacked side by side in the cathode flow direction to form a block. The permeability of the substrate to the fuel may be varied along the direction of fuel flow within the cavity to control the rate of transport of the hydrocarbon fuel across the substrate to active anode(s) of the solid oxide fuel cells. The active electrode may also act as a reforming catalyst for on-cell reforming in the system. In some examples, the permeability of the substrate along the fuel flow direction may be selected to provide for substantially uniform consumption of the hydrocarbon fuel in the fuel source and/or to reduce temperature difference in the system along the fuel flow direction.

Solid oxide fuel cell systems may be configured to reform hydrocarbon fuels (e.g., methane) from a fuel stream to produce hydrogen, among others, for use in operation the solid oxide fuel cell. One example reforming process may include steam reforming. A system may include a fuel reformer that is separated from the fuel cell such that the reforming process is considered off-cell or ex-situ. In some examples using ex-situ reformers, thermal energy from a fuel cell stack (which may result from the inefficiencies of the electrochemical process of the fuel cell) may be transported from the fuel cell stack to the air, then from the air to the reformer plates and then into the fuel. Not only does such a system require a separate reformer device with sufficient surface area to overcome convective resistance, it also follows that the cathode temperature flowing over the stack rises on the order of, e.g., 100° C. from inlet to outlet. If the reforming duty is closely coupled to the fuel cell stack heat generation, the temperature rise in each strip may be reduced to on the order of 7° C., such that a 100° C. temperature rise across five strips would become 33° C. Degradation at higher temperatures may be an issue for existing fuel cell technology, and operating at a more favorable average temperature may provide longevity benefits for the stack.

Conversely, a system may be configured for on-cell (or in-situ) reformation of the hydrocarbon fuel by using an active anode electrode that serves as a catalyst for the reforming. On-cell reforming may be beneficial from both a cost and operational standpoint. For example, from a cost standpoint, eliminating a separate fuel reformer may reduce the size of the overall fuel cell system as well as the complexity. From an operational standpoint, moving the reforming heat duty into a fuel cell stack may result in a smaller temperature rise across the stack. In some examples, this may allow the fuel cell stack to operate in a small temperature band around its optimum temperature from a performance and durability perspective. In addition the stack may be operated at a higher power density without exceeding temperature limits, which will allow for a smaller stack size and lower stack cost.

Examples of on-cell reforming include electrolyte-supported-cell (ESC) and anode-supported-cell (ASC) technologies. However, on-cell reforming may be challenging for each of these technologies, e.g., because incoming fuel with a high methane concentration is exposed to catalytic materials on the anode electrode (such as Ni) causing it to reform. The resulting endotherm from sudden reforming may rapidly cool the fuel inlet of the stack for ESC and ASC technologies. Sudden cooling near the fuel inlet which may result in adverse thermal stress and performance conditions.

In accordance with examples of the disclosure, a fuel cell system may utilize fuel cells with tubular substrates that define a fuel flow cavity for a fuel source, where the permeability of the tubular substrate to the hydrocarbon fuel within the source varies along the fuel flow direction. Such a configuration may selectively control the rate of transport of the hydrocarbon fuel across the substrate to an active anode, which also acts as a reforming catalyst, on the opposite surface of the tubular substrate. As used herein, permeability of a substrate may be defined as the ability to permit fluid flow across the boundary of the substrate and is described by term porosity over tortuosity squared or ε/τ². Controlling the rate of transport of the hydrocarbon fuel across the substrate by varying the permeability of the cell substrate defining the flow of the fuel source may allow for control of the reforming profile within the fuel cell and the rate of heat absorption by the reforming reaction. In some examples, the permeability of the substrate along the fuel flow direction may be tailored to “smooth out” or otherwise provide a desired temperature profile within a tube bundle, e.g., to help minimize thermal stresses which may result from a sharp endotherm at the fuel inlet of the bundle.

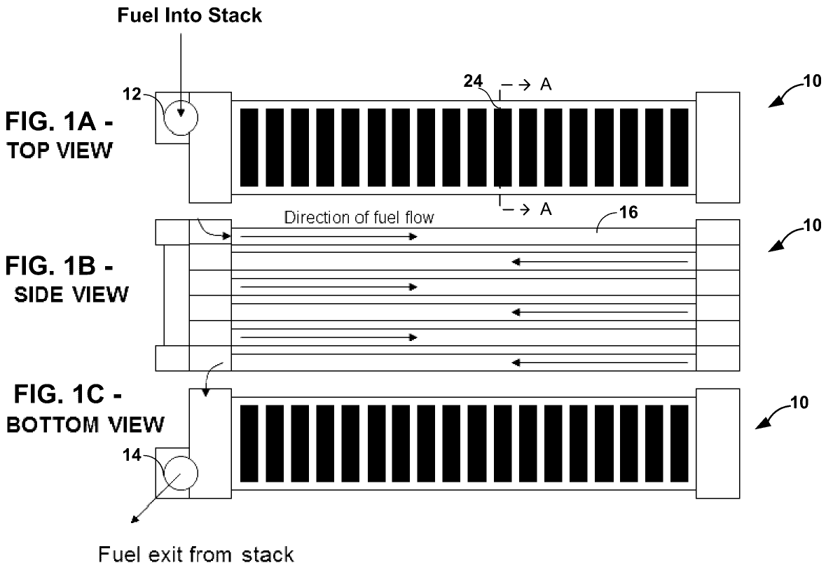

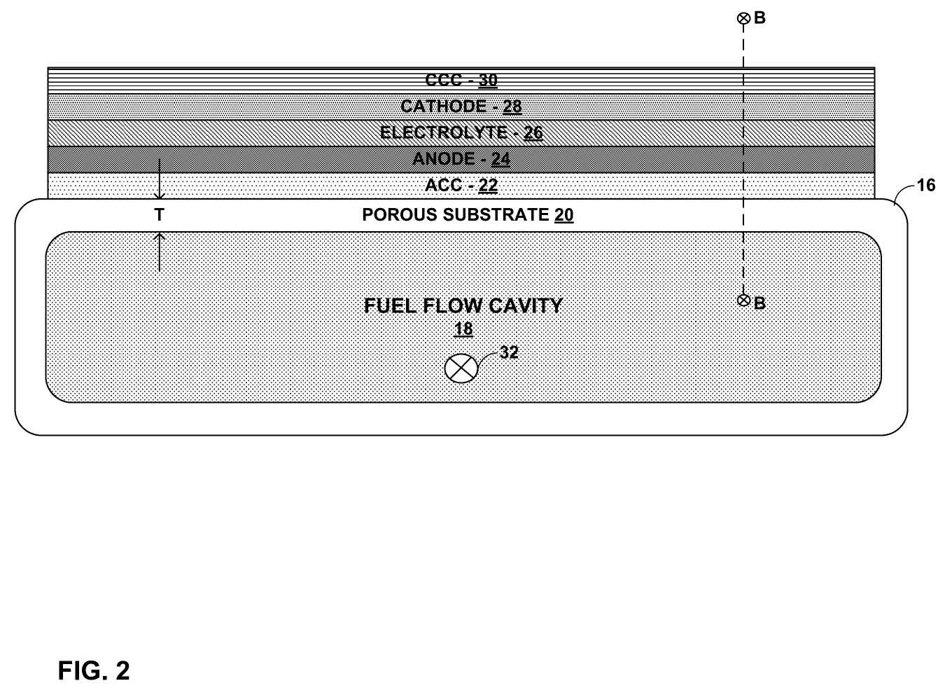

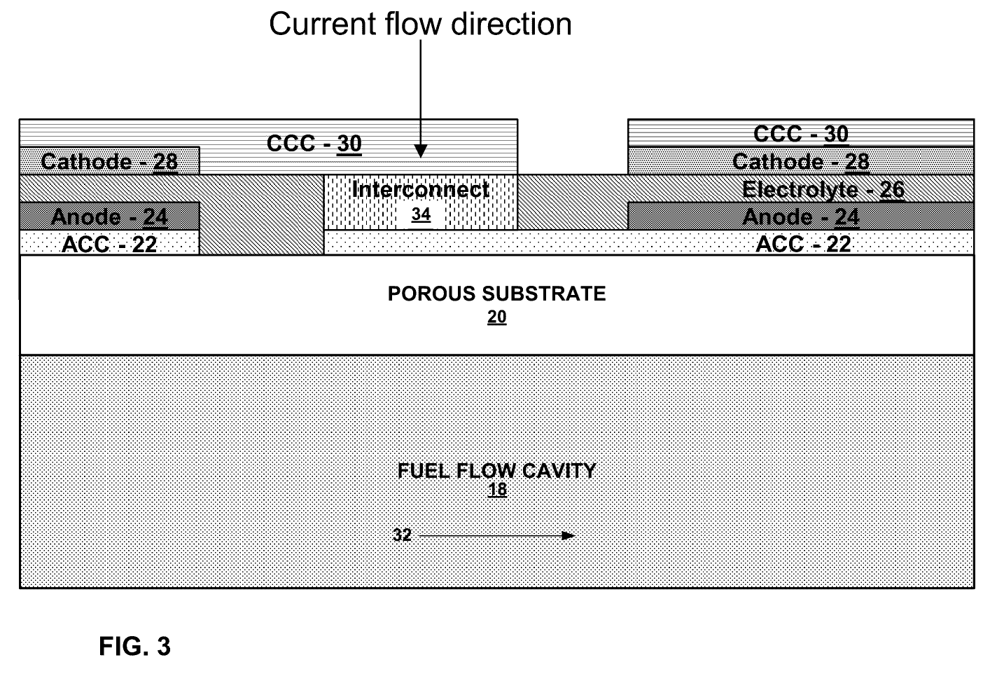

FIGS. 1A-1C are schematic diagrams illustrating an example fuel cell stack 10 of a fuel cell system from top, side, and bottom views, respectively. FIG. 2 is a schematic diagram illustrating a cross-sectional view taken along cross-section A-A shown in FIG. 1A. FIG. 3 is a schematic diagram illustrating a cross-sectional view taken along cross-section B-B shown in FIG. 2. Fuel cell stack 10 is only one example configuration in which tubular substrates with variable permeability along the flue flow direction may be employed and other fuel cell system configurations are contemplated.

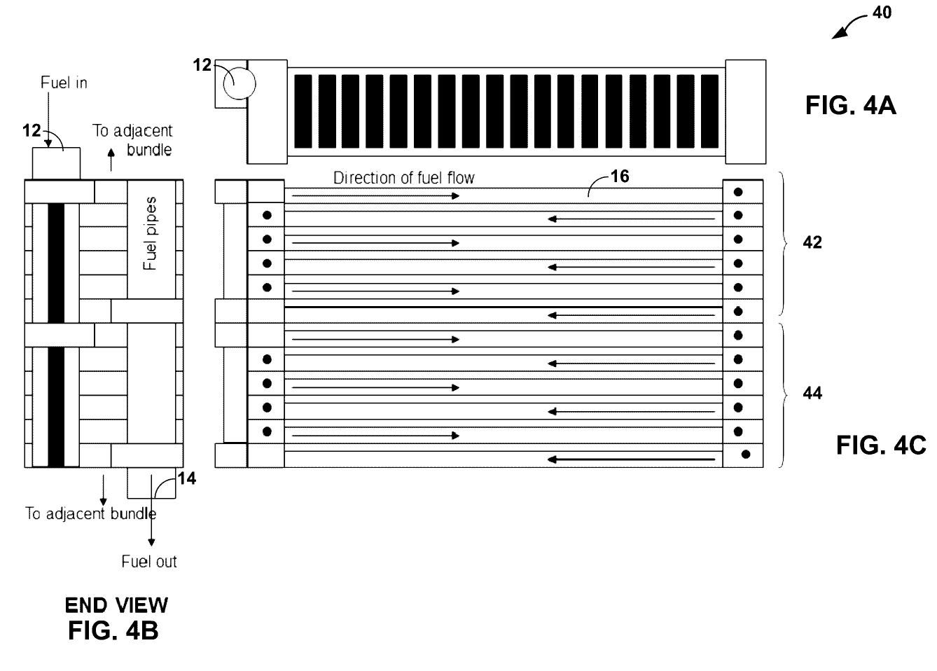

As shown, fuel cell stack 10 includes a tubular substrate in the form a plurality of individual tubes (such as, e.g., tube 16), which define a fuel flow cavity 18 within porous substrate 20. A fuel source including a hydrocarbon fuel used for the electrochemical reaction by the solid oxide fuel cell may be fed into first tube 16 of stack 10 via inlet 12. In combination, the individual tubes of fuel cell stack 10 may define fuel flow cavity 18 used to feed the hydrocarbon fuel to the fuel cell side of the electrochemical cells within stack 10. The fuel may travel through fuel cavity 18 of the tubes in stack 10 in fuel flow direction 22 and exit stack 10 via opening 14. Although tubular substrate 20 defining fuel flow cavity 18 is illustrated in the example as being formed of multiple individual tubes, examples are not limited as such. For example, a fuel cell system may include only a single continuous tube rather than multiple tubes. As another example, a fuel cell system may include multiple bundles connected in series, where each bundle includes a plurality of tubes, e.g., as shown FIGS. 4A-4C.

Fuel cell stack 10 includes one of more electrochemical cells (e.g., cell 24). Any suitable solid oxide fuel cell system including one or more electrochemical cells may be utilized in the present disclosure. Suitable examples include those examples described in U.S. Patent Application Publication No. 2003/0122393 to Liu et al., published May 16, 2013, the entire content of which is incorporated by reference. In the illustrated example, cell 24 includes anode conductive layer (ACC) 22, anode layer 24, electrolyte layer 26, cathode layer 28, and cathode conductive layer (CCC) 30. Each respective layer may be a single layer or may be formed of any number of sub-layers, and may be formed of any suitable material including, e.g., those examples described in U.S. Patent Application Publication No. 2003/0122393 to Liu et al.

Respective electrochemical cells 24 are coupled together in series by interconnect 34. In each electrochemical cell 24, anode conductive layer 22 conducts free electrons away from anode 24 and conducts the electrons to cathode conductive layer 30 via interconnect 34. Cathode conductive layer 30 conducts the electrons to cathode 28. Interconnect 34 may be embedded in electrolyte layer 26, and may be electrically coupled to anode conductive layer 22, and may be electrically conductive in order to transport electrons from one electrochemical cell to another. The illustrated example is a segmented-in-series arrangement deposited on a flat, porous tube 16, although it will be understood that the present disclosure is equally applicable to segmented-in-series arrangements members having different geometries, such on a circular, porous tube 16. As shown, respective layers of the electrochemical cell 24 are on outer surface of porous substrate 20, which provides structural support for cell 24.

The electrochemical cells of stack 10 include an oxidant side and fuel side. The oxidant of the oxidant side is generally air, but could also be pure oxygen (O₂) or other oxidants, e.g., including dilute air for fuel cell systems having air recycle loops, and is supplied to electrochemical cell 24 from the oxidant side. Conversely, on the fuel side, a hydrocarbon fuel (e.g., methane, ethane, propane, butane, and the like) of the fuel source with fuel flow cavity 18 is supplied to the electrochemical cell 24 by permeating through porous substrate 20 to ACC 22/anode 24. In the case of on-cell reforming, ACC 22/anode 24 may be catalytically active with regard to the reforming process, e.g., by including Ni and/or Pd, Pt Rh, Ru, or other reforming catalysts. As described above, in examples of the disclosure, the permeability of porous substrate 20 to the hydrocarbon fuel (e.g., methane) in the fuel source may vary along the direction of fuel flow 32 within fuel flow cavity 18. The permeability of substrate refers to the ability to permit fluid flow across the boundary of the substrate and is described by term porosity over tortuosity squared or ε/τ². By varying the permeability of substrate 20, the rate of transport of hydrocarbons from the fuel to ACC22/anode 24 may be controlled.

Various techniques may be used to provide for the desired variable permeability of substrate 20 along flow direction 32. For example, the porosity of substrate 20 may be varied along flow direction 32 to provide for the desired permeability of substrate 20 in flow direction 32. Increasing the porosity of substrate 20 may increase the permeability of substrate 20 while decreasing the porosity of substrate 20 may decrease the permeability of substrate 20. The porosity of the substrate 20 may be varied by forming portions of substrate with different material compositions. For example, in the case of two tubes connected in series, the first tube may be formed of a material that has a different porosity that the material used to form the second tube. In other example, substrate 20 may be formed of the same material throughout but the porosity may be varied by changing the sintering process used for that substrate.

Suitable materials for forming porous substrate include, e.g., ceramics. In some examples, substrate 20 may be catalytically inert, e.g., as compared to ASC technology where a substrate may be made from a nickel based material which is catalytically active. Alternatively or additionally, substrate 20 may be substantially electrically non-conductive. As noted above, substrate 20 may provide structural support for layers of cell 24 in addition to defining fuel flow cavity 18. An example material for substrate 20 is MMA (MgO+MgAl₂O₄).

Additionally or alternatively, the thickness of substrate 20 (labeled as “T” in FIG. 2) may be varied along flow direction 32 to provide for the desired permeability of substrate 20 in flow direction 32. Increasing the thickness, T, of substrate 20 may decrease the permeability of substrate 20 while decreasing the thickness, T, of substrate 20 may increase the permeability of substrate 20. In the case of a two tubes connected in series, the thickness of the first tube may be different that the second tube. Additionally or alternatively, the thickness, T, of substrate 20 for a single tube may be variable, e.g., by tapering the thickness in fuel flow direction 32.

The permeability of substrate 20 may be varied to provide for one or more desirable results by controlling the rate of transport of the hydrocarbon fuel to active ACC 22/anode 24. The permeability of substrate 20 may vary within a single tube and/or may be varied on a tube-by-tube basis for systems including multiple tubes in series. For example, the permeability of substrate 20 in the case of a single, continuous tube may be varied from the inlet to the outlet of the tube along flow direction 32. For multiple tubes, individual tubes may have uniform or non-uniform permeability which may be the same or different among the multiple tubes. In some examples, a system may include two or more bundles of individual tubes connected in series, e.g., as shown in FIG. 4A-4C. The tubes in a single bundles may have the same or different permeability and the permeability defined by the tubes in the bundles may be the same or different among bundles. In some examples, permeability may be as low as a porosity over tortuosity squared or ε/τ² of about 0.015 up to as high as about 0.10.

As described herein, varying the permeability of substrate 20 may be used to control the rate of transport of the hydrocarbon fuel from fuel flow cavity 20 through substrate 20 to active ACC 22/anode 24. Such control may be used to provide for one or more desirable results. For example, controlling the rate of transport of the hydrocarbon fuel along flow direction 32 may be used to control the rate at which the hydrocarbons reform within fuel cell stack/bundle and/or control the rate of heat absorption by the reforming reaction. The ability to control the flux of hydrocarbons reaching the active anode may be used to smooth out the temperature profile within the bundle/stack, e.g., to help to minimize thermal stresses resulting from a sharp endotherm at the inlet 12 of tubular substrate 20 compared to that of an unregulated bundle. In such examples, the sharp endotherm at inlet 12 may be reduced by providing substrate 20 with a lower permeability nearer inlet 12 compared to further downstream along flow direction 32, e.g., nearer outlet 14. Varying the permeability of substrate 20 in the manner described herein may provide for thermal load balancing within the stack/bundle and/or provide for tailored fuel consumption, e.g., to provide for a substantially uniform fuel consumption. In addition, putting higher permeability tubes toward the outlet 14 will provide better access for fuel to reach anodes to help improve reforming conversion as we have increasingly small amounts of CH4 left in the fuel supply and to help prevent becoming concentration loss dominated.

FIGS. 4A-4C is a schematic diagram illustrating an example fuel cell system 40 including two bundles (first bundle 42 and second bundle 44), with multiple tubes in each bundle, from top, end, and side views. In the example shown, each bundle contains six tubes in a series (such as tube 16). System 20 may function substantially similar to that of system 10, and may include tubular substrate 20 defining fuel flow cavity 18 in which the permeability varies between inlet 12 and outlet 14 along flow direction 32.

### Examples

Various experiments were carried out to evaluate aspects of one or more examples of the disclosure. In one example, a fuel cell bundle with six tubes of equal length defining a porous substrate was modeled. In a first instance, the six tubes were modeled with substantially constant permeability (as designated by the term porosity over tortuosity squared or ε/τ²) of approximately 0.057. In a second instance, the six tube were modeled with varying permeability, ε/τ², (tube 1, nearest inlet, =0.018, tube 2=0.023, tube 3=0.032, tube 4=0.045, and tubes 5 and 6=0.057) to provide for low permeability at the inlet versus the outlet. The purpose of this variable permeability was an attempt to selectively use the methane in the fuel source so that its consumption was substantially uniform throughout the bundle.

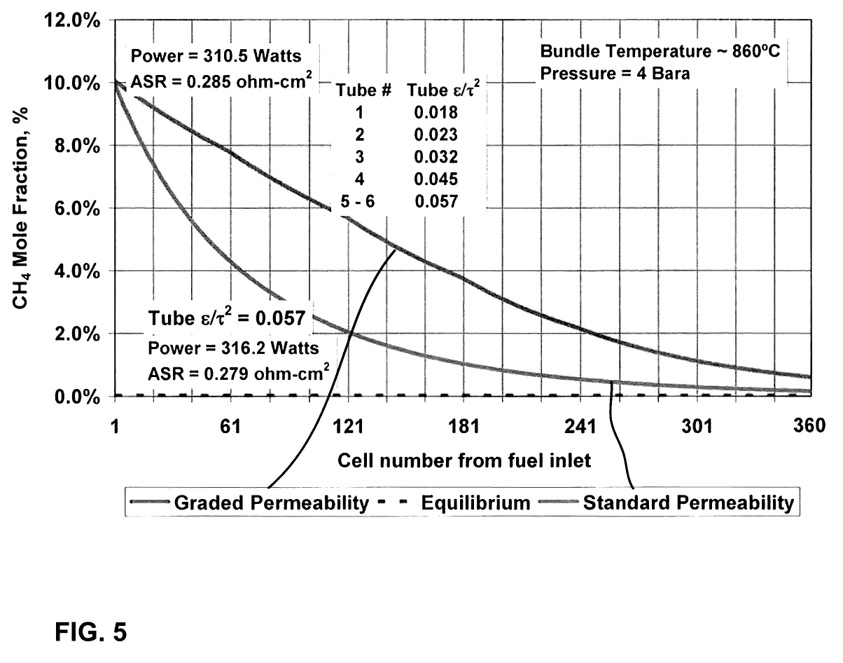

FIG. 5 is plot showing the profile of the methane mole fraction in the bulk fuel through the bundle for both the constant permeability model and variable permeability model for an input of a fuel initially containing approximately 10% methane. The pressure was set at approximately 4 bars and the temperature was set at approximately 860 degrees Celsius. As show, for the bundle with constant and relatively high permeability for all 6 tubes, the methane is consumed quickly in the first two tubes. In the second bundle with the permeability being varied from inlet to outlet, there was a nearly linear consumption of the methane. However, there was a reduction in the produced power of the bundle from 316.2 Watts to 310.5 Watts, or 1.8%.

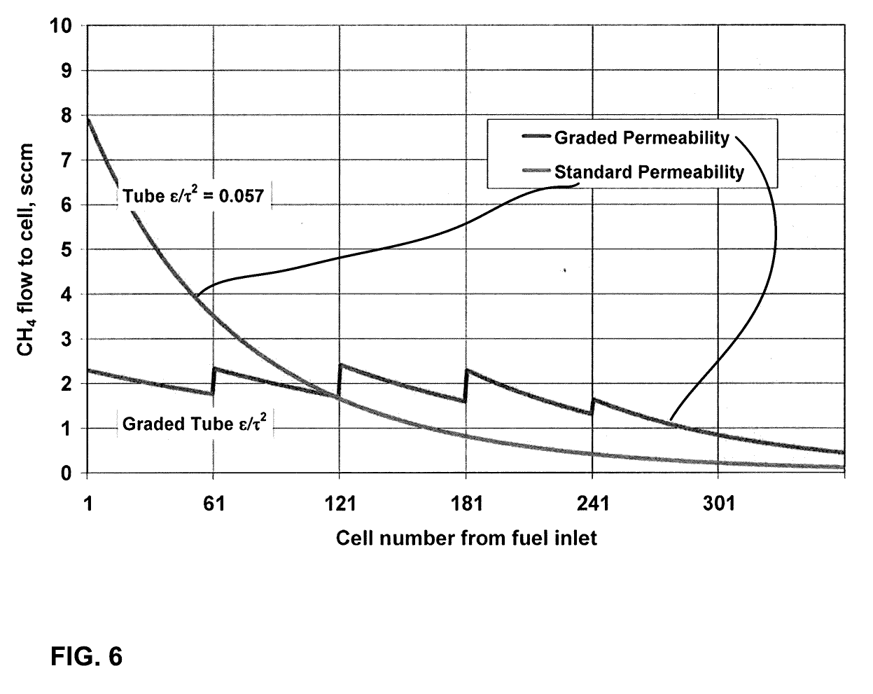

FIG. 6 is a plot showing the profile of methane flux to the active anode area of each cell pair in the bundle is shown for the same two models. As shown, by reducing the permeability of tubes 1 through 4, a fairly constant methane flux was produced in the first 4 tubes. By tubes 5 and 6, the methane concentration in the bulk fuel stream has fallen to a point where our current characteristic tube ε/τ² did not permit a flux similar to at the inlet of the bundle.

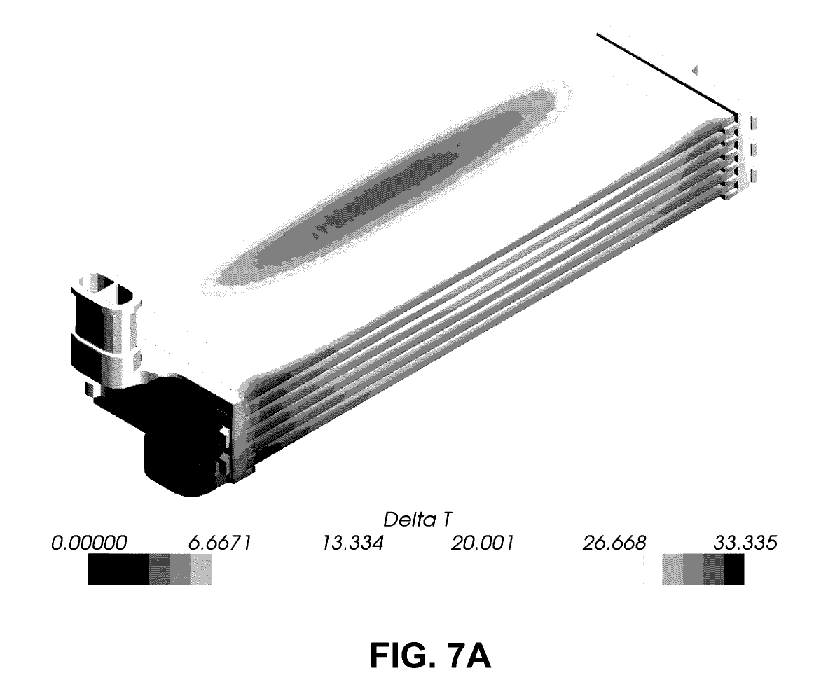

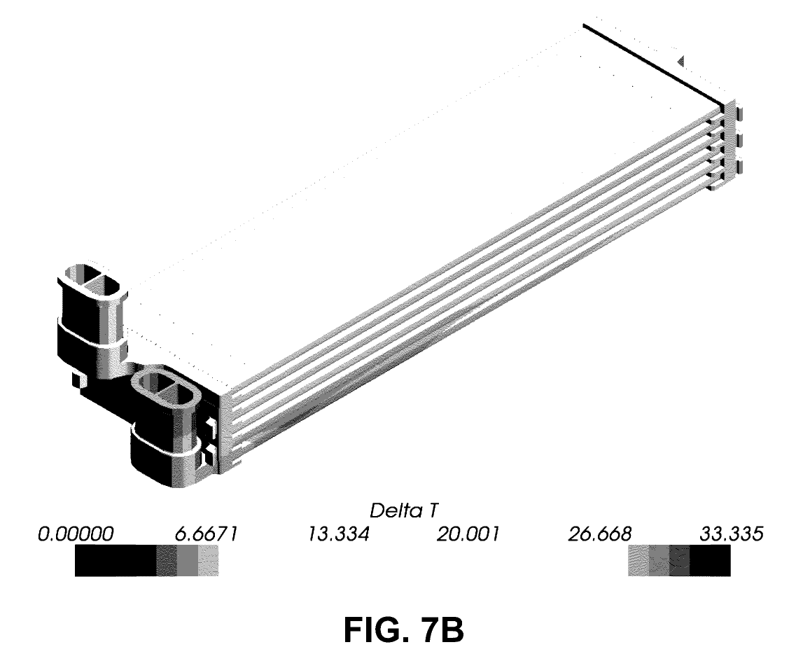

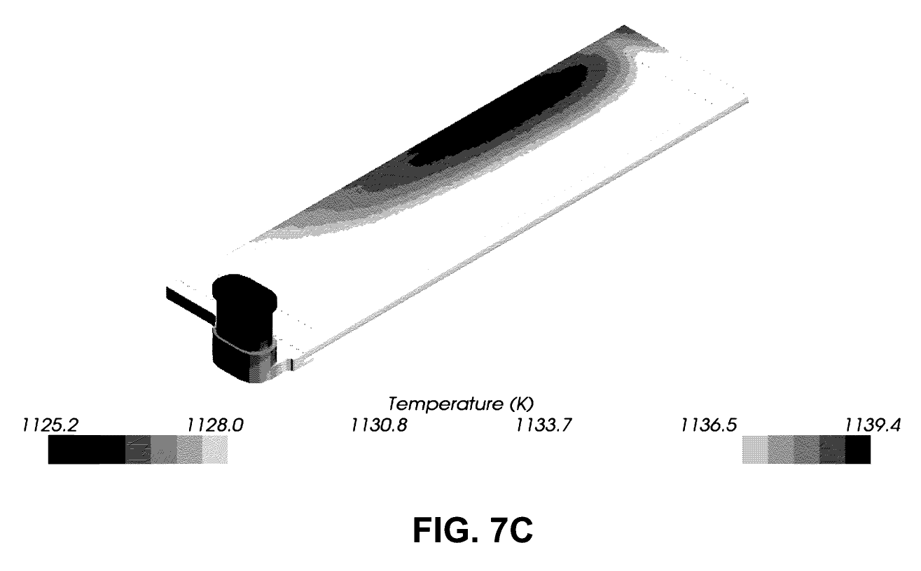

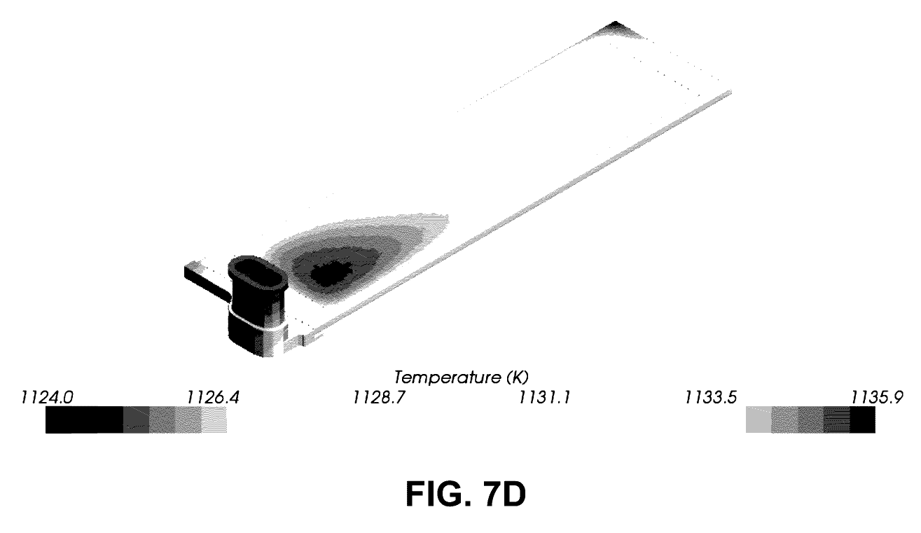

FIGS. 7A-7D are illustrations of bundle temperature profiles for the various example bundle configurations. FIG. 7A illustrates a bundle temperature profile without internal reforming and FIG. 7B illustrates a bundle temperature profile without internal reforming. A comparison of FIG. 7A to FIG. 7B shows the effects of reforming inside the fuel cell bundle compared to external reforming. FIG. 7C illustrates a bundle temperature profile with a low permeability inlet tube and FIG. 7D illustrates a bundle temperature profile with a high permeability inlet tube. A comparison of FIG. 7C to FIG. 7D shows the influence of the inlet tube permeability on the temperature.

Various embodiments of the invention have been described. These and other embodiments are within the scope of the following claims.

1. A solid oxide fuel cell system comprising:
a tubular substrate defining a fuel flow cavity within the tubular substrate;
a plurality of solid oxide fuel cells on a surface of the tubular substrate, each cell including an anode electrode, a cathode electrode, and electrolyte,
wherein the anode electrode, cathode electrode, and electrolyte are configured to form an electrochemical cell, wherein, during fuel cell during operation, fuel flows within the fuel flow cavity of the tubular substrate along a fuel flow direction from an inlet to an outlet of the fuel flow cavity, and wherein a permeability of the tubular substrate to the fuel varies along the fuel flow direction.

2. The system of claim 1, wherein a permeability of the tubular substrate is lower at nearer the inlet of the fuel flow cavity compared to a permeability of the tubular substrate nearer the outlet of the fuel flow cavity.

3. The system of claim 1, wherein a porosity of the tubular substrate varies along the fuel flow direction to vary the permeability of the tubular substrate relative the fuel along the fuel flow direction.

4. The system of claim 1, wherein the tubular substrate includes a first tube and second tube, wherein the first tube is nearer the inlet of the fuel flow cavity than the second tube, wherein a permeability of the first tube is less than a permeability of the second tube.

5. The system of claim 1, wherein the tubular substrate includes a first bundle including a first plurality of tubes, and a second bundle including a second plurality of tubes, wherein a permeability of the first plurality of tubes is substantially the same, wherein a permeability of the second plurality of tubes is substantially the same, and wherein the permeability of the first plurality of tubes is less than the second plurality of tubes.

6. The system of claim 5, wherein the first bundle in nearer the inlet of the fuel flow cavity than the second bundle.

7. The system of claim 1, wherein the tubular substrate includes in individual tube, wherein a permeability of the individual tube is one of substantially constant along the fuel flow direction or variable along the fuel flow direction.

8. The system of claim 1, wherein the tubular substrate supports the plurality of solid oxide fuel cells.

9. The system of claim 1, wherein the tubular substrate is formed on a ceramic material that is substantially electrically non-conductive.

10. The system of claim 1, wherein the permeability of the tubular substrate along the fuel flow direction is such that consumption of the fuel is substantially uniform from the inlet to the outlet of the fuel flow cavity.

11. The system of claim 1, wherein the fuel cell system is configured as a flattened tubular, integrated planar series connected solid oxide fuel cell system.

12. A method comprising generating electricity via a solid oxide fuel cell system, wherein the solid oxide fuel cell system comprises:
a tubular substrate defining a fuel flow cavity within the tubular substrate;
a plurality of solid oxide fuel cells on a surface of the tubular substrate, each cell including an anode electrode, a cathode electrode, and electrolyte,
wherein the anode electrode, cathode electrode, and electrolyte are configured to form an electrochemical cell, wherein, during fuel cell during operation, fuel flows within the fuel flow cavity of the tubular substrate along a fuel flow direction from an inlet to an outlet of the fuel flow cavity, and wherein a permeability of the tubular substrate to the fuel varies along the fuel flow direction.

13. The method of claim 12, wherein a permeability of the tubular substrate is lower at nearer the inlet of the fuel flow cavity compared to a permeability of the tubular substrate nearer the outlet of the fuel flow cavity.

14. The method of claim 12, wherein a porosity of the tubular substrate varies along the fuel flow direction to vary the permeability of the tubular substrate relative the fuel along the fuel flow direction.

15. The method of claim 12, wherein the tubular substrate includes a first tube and second tube, wherein the first tube is nearer the inlet of the fuel flow cavity than the second tube, wherein a permeability of the first tube is less than a permeability of the second tube.

16. The method of claim 12, wherein the tubular substrate includes a first bundle including a first plurality of tubes, and a second bundle including a second plurality of tubes, wherein a permeability of the first plurality of tubes is substantially the same, wherein a permeability of the second plurality of tubes is substantially the same, and wherein the permeability of the first plurality of tubes is less than the second plurality of tubes.

17. The method of claim 16, wherein the first bundle in nearer the inlet of the fuel flow cavity than the second bundle.

18. The method of claim 12, wherein the tubular substrate includes in individual tube, wherein a permeability of the individual tube is one of substantially constant along the fuel flow direction or variable along the fuel flow direction.

19. The method of claim 12, wherein the tubular substrate is formed on a ceramic material that is substantially electrically non-conductive.

20. A method comprising forming a solid oxide fuel cell system, wherein the solid oxide fuel cell system comprises:
a tubular substrate defining a fuel flow cavity within the tubular substrate;
a plurality of solid oxide fuel cells on a surface of the tubular substrate, each cell including an anode electrode, a cathode electrode, and electrolyte,
wherein the anode electrode, cathode electrode, and electrolyte are configured to form an electrochemical cell, wherein, during fuel cell during operation, fuel flows within the fuel flow cavity of the tubular substrate along a fuel flow direction from an inlet to an outlet of the fuel flow cavity, and wherein a permeability of the tubular substrate to the fuel varies along the fuel flow direction.
